(19) United States
(12) Patent Application Publication
(10) Pub. No.: US 2006/0045824 A1
(43) Pub. Date: Mar. 2, 2006

(54) Gas treatment device and system, and method for making the same

(76) Inventors: Michael Ralph Foster, Columbia Ville, MI (US); Robert Allen Sarsfield, Grand Blanc, MI (US)

Correspondence Address: PAUL L. MARSHALL;DELPHI TECHNOLOGIES, INC., Legal Staff, Mail Code: 480-410-202, P.O. Box 5052, Troy, MI, 48007-5052, US

(21) Appl. No.: 10/925,891

(22) Filed: Aug. 25, 2004

(51) Int. Cl. B01D 50/00; B01D 53/34

(52) U.S. Cl. 422/179; 422/177; 422/211

(57) ABSTRACT

One embodiment of a gas treatment device comprises: a substrate, a secondary mat support having a secondary mat basis weight, wherein the secondary mat support is disposed concentrically about at least a portion of the substrate, and a primary mat support having a primary mat basis weight, wherein the primary mat support is disposed concentrically and substantially completely about the substrate, further wherein the secondary mat basis weight is substantially less than the primary mat basis weight. One embodiment of a method for making the gas treatment device comprises: determining a first selected length for the primary mat support sufficient for the primary mat support to be disposed substantially completely about the substrate concentrically, determining a parameter of at least one subcomponent of the gas treatment device, and determining a second selected length for the secondary mat support based on the parameter.

### TECHNICAL FIELD

The present invention relates to gas treatment devices, individually and in their various combinations, including catalytic converters for gasoline and diesel engines, adsorbers for hydrocarbons and oxides of nitrogen, evaporative emissions and hydrocarbon scrubbing devices, diesel particulate traps, nonthermal plasma reactors and fuel cell reformers, each having a substrate through which emission gases flow, wherein the substrate is retained in a housing by compressible mat support materials.

### BACKGROUND OF THE INVENTION

Gas treatment devices for vehicle applications typically have of one or more ceramic substrates with many small channels for exhaust gases to flow through. The ceramic substrates tend to have the following characteristics: (1) capable of operating at temperatures up to about 1,000 degrees Celsius (C); (2) capable of withstanding exposure to hydrocarbons, nitrogen oxides, carbon monoxide, carbon dioxide, sulfur and/or sulfur oxides; and (3) having sufficient surface area and structural integrity to support a desired catalyst or other exhaust gas treating composition. Some possible materials include cordierite, silicon carbide, metallic foils, alumina sponges, porous glasses, and the like, and mixtures comprising at least one of the foregoing materials. Some ceramic materials include “HONEY CERAM”, commercially available from NGK-Locke, Inc., Southfield, Mich., and “CELCOR”, commercially available from Corning, Inc., Corning, N.Y. Although the substrate can have many different sizes and geometries, the size and geometry are preferably chosen to optimize surface area within the given gas treatment device design parameters. Typically, the substrate has a honeycomb geometry, with the combs being any multisided or rounded shape, with substantially square, triangular, pentagonal, hexagonal, heptagonal, or octagonal or similar geometries preferred due to ease of manufacturing and increased surface area.

The ceramic substrates are generally retained in a housing or shell by a compressible mat support material. The housing comprises a material that is capable of withstanding the type of gas, maximum temperature of the gas, maximum temperatures reached by the substrate, and other related operating conditions including, but not limited to, under car salt exposure, temperature, corrosion, and the like. Generally, ferrous materials are employed, such as ferritic stainless steels, and the like. Some possible ferritic stainless steels can include stainless steel grades such as the 400-Series, for example, SS-409, SS-439 and SS-441, with grades SS-409 and SS-439 preferred. The size and shape of the housing comprises a size and shape which corresponds to the size and shape of the substrate/compressed mat material subassembly that is disposed within the housing.

The small channels of each ceramic substrate of a catalytic converter, for example, are coated with a high-surface area washcoat and one or more catalysts. The catalyst may comprise one or more catalyst materials that are wash coated, imbibed, impregnated, physisorbed, chemisorbed, precipitated, or otherwise applied to the substrate. The particular catalyst(s) are chosen based upon the type of gas treatment device and its location in the vehicle. Possible catalyst materials include noble metals, such as platinum, palladium, rhodium, iridium, osmium, and ruthenium; other metals, such as tantalum, zirconium, yttrium, cerium, nickel, copper, and the like; active carbon, titanium dioxide (TiO₂) and the like; as well as metal oxides; alloys, and mixtures comprising at least one of the foregoing catalysts, and the like. The catalyst can optionally include a base metal oxide for the reduction of nitrogen oxides. The catalyst promotes desired chemical reactions without taking part in the reactions. To function with significant efficiency a catalytic converter must be warmed by the engine exhaust flow to a minimum operating temperature. This is normally about 350 degrees C. or greater for automotive catalytic converters with gasoline engines. When operating at these temperatures or above, at a stoichiometric air/fuel ratio, a catalytic converter will simultaneously oxidize and reduce engine exhaust gas contaminates such as hydrocarbons, nitrogen oxides and carbon monoxide into compounds such as carbon dioxide, nitrogen and water. For diesel engine applications, hydrocarbons, carbon monoxide, and the volatile portion of diesel particulates are oxidized by diesel oxidation catalysts to harmless byproducts, starting at temperatures as low as 150 degrees C. In addition, catalyzed diesel particulate filters, or “traps”, capture the nonvolatile components of diesel particulates for oxidation under higher temperature conditions. However, the reduction of oxides of nitrogen is more difficult due to the presence of oxidizing conditions in normal diesel exhaust.

Located in between the substrate (or substrates) and the gas treatment device's housing is a mat support material that insulates the housing from both the high exhaust gas temperatures and the exothermic catalytic reaction occurring within the substrate. The mat support material, which enhances the structural integrity of the substrate by applying compressive radial forces about it, reducing its axial movement, and retaining it in place, is concentrically disposed around the substrate to form a substrate/mat support subassembly. The mat support can either be an intumescent material, for example, one which contains ceramic materials, and other conventional materials such as organic binders and the like, or combinations comprising at least one of the foregoing materials, and a vermiculite component that expands with heating to maintain firm uniform compression, or nonuniform compression, if desired, or a nonintumescent material, which does not contain vermiculite, as well as materials which include a combination of both. Nonintumescent materials include materials such as those sold under the trademarks “NEXTEL,” “SAFFIL” and “INTERAM 1101 HT” by the “3M” Company, Minneapolis, Minn., or those sold under the trademark, “FIBERFRAX” and “CC-MAX” by the Unifrax Co., Niagara Falls, N.Y., and the like. Intumescent materials include materials, sold under the trademark “INTERAM 100” by the “3M” Company, Minneapolis, Minn., as well as those intumescents which are also sold under the aforementioned “FIBERFRAX” trademark, as well as combinations thereof and others. These mat materials compress and conform to adjust for manufacturing tolerances, retaining the catalyst in its alloy steel housing and sealing the area between the substrate and the housing so that exhaust gases do not bypass the catalyst. Normally this mat material, which can be from about 1 to 10 millimeters (mm) thick, is cut from a large sheet so as to produce a tongue feature at one end of the mat and a matching groove at the other end. The mat is wrapped about the periphery of the substrate so that the tongue and groove fit together and form a seal at the resulting joint, thereby avoiding exhaust gas bypass of the substrate channels even when the periphery of the substrate varies in size due to tolerances. In the prior art, only one piece of mat support is generally used to retain the substrate per gas treatment device.

After wrapping the mat around the substrate, the substrate can be installed in the housing by one of several processes. For the “stuffing” process, a funnel-shaped “stuffing cone” is used to compress the mat as the substrate is pushed through the cone and into the housing of the gas treatment device. For the “clamshell” assembly process, two half-shells with common connecting flanges are used. A mat-wrapped substrate is placed into the first clamshell, and then the second clamshell is placed on top of the first one so that the flanges are aligned. A machine then compresses the clamshells together, and the flanges are welded securely. For the “tourniquet” process, a mat-wrapped substrate is placed into a partially-formed, unwelded shell. A machine pulls on the edges of the shell until a selected load or diametrical distance is reached, and the shell is then welded together.

For each of these processes, the variation in size for the subcomponents of each assembly can produce, in some cases, relatively large variations in the annular gap (or “annulus”) between the substrate and housing. Also the mat basis weight for different pieces of mat support with the same nominal basis weight varies significantly. When the variation in part sizes causes the annular gap to reach a minimum (the “minimum annulus condition”) and the mat basis weight reaches a maximum in a given assembly, a condition of maximum mount density is produced. Under this condition the mat pressure on the substrate can become high enough to cause the substrate to fracture. Since the substrate accounts for about 90% of the total cost of an exhaust treatment device, these fractures must be minimized or eliminated.

When installing two substrates in one step with the “stuffing” process, it is important that the substrates are aligned with one another prior to stuffing them into the shell. If they are not aligned, they tend to remain misaligned as they pass through the stuffing cone and into the shell. Misalignment causes higher mat pressure on the substrates because it causes the adjoining substrates to push each other in opposing directions, i.e. further into the mat support. The increased pressure resulting from this condition can be great enough to shear off a section of the substrate.

Substrates have recently been developed with higher cell densities and thinner cell walls. Some typical configurations include 600 cells per square inch (cpsi) with 0.0035 inch thick cell walls, and 900 cpsi with 0.0025 inch thick cell walls. These “thin wall” substrates have reduced compressive strength, making it more difficult to properly retain them without causing fractures. When using a thin wall substrate together with the amount of mat suitable for a substrate having 400 cpsi and 0.0065 inch thick walls, crushing or shearing of the thin wall substrate can occur. This is more likely when the substrate diameter is at the upper end of its tolerance range, or when two substrates are misaligned relative to each other during assembly.

To mitigate these problems a “size-to-fit” process can be employed, in which the size of a given housing is varied in direct proportion to the size of a given substrate. In this manner, a substrate at the upper limit of the size tolerance range can be accommodated by building a steel housing that is the same amount larger than a nominal size housing as the large substrate is bigger than a nominal size substrate. This results in the proper amount of mat pressure being applied to the substrate, to retain it in the shell while not causing it to fracture during assembly or use. However, the cost of adjusting the housing size relative to the substrate size is significant, as is the cost and lead time to purchase the necessary tooling. For these reasons, a lower cost process is needed which provides the proper amount of mat pressure to retain substrates of different sizes that occur within the normal tolerance range without causing fractures, and which is also cost-effective and capable of quick implementation.

The proper mat pressure on the substrate is obtained by taking into consideration the type of mat material, the “mount density” for the mat in the annular space it occupies between the substrate and the housing, the mass of the substrate, the vibrational loads which the substrate retention system must withstand, the coefficient of friction between the mat and housing as well as between the mat and substrate, the rate of mat compression during assembly of the gas treatment device and the amount of any over compression of the mat during assembly. Mat support materials are produced in different “basis weights,” i.e. mat weight per unit area. Common basis weights include 3100 grams per square meter (g/m²), 6200 g/m², etc. Mat basis weight is typically chosen in order to obtain a selected mount density such as, for example, 0.85-1.20 grams per cubic centimeter (g/cm³) for the intumescent material sold under the trademark “INTERAM 100” by the “3M” Company, Minneapolis, Minn. The mat basis weight selected depends on the substrate-to-housing annular space, the tolerance range of the substrate and the shell, and other factors such as the mat thickness required to attain the desired temperature for the outer surface of the housing. Mount density is the most important characteristic considered during the design of a gas treatment device because it is related to the pressure on the substrate, substrate retention force, force on the substrate due to mat expansion during vehicle operation, and the rate of mat erosion. Mount density can be obtained for a particular gas treatment device assembly by determining the annular space or “annulus” between the substrate and the inner housing surface, together with the mat's basis weight, as follows:
Mount Density(g/cm³)=Mat Basis Weight(g/cm²)/Annular Space(cm)

For example, using a mat basis weight of 6200 g/m² and a 6.0 mm annular space between the substrate and housing, the mount density=6200 g/m²/6.0 mm=0.6200 g/cm²/0.60 cm=1.03 g/cm³. Alternatively, the mount density can be expressed as 6200 g/m²/[(10.000 cm²/m²)(6.0 mm)(1 cm/10 mm)]=1.03 g/cm³. A mat support with a lower basis weight would result in a lower mount density, as would a substrate/housing combination with a larger annular space.

Mount density is also an important consideration during the actual assembly of a substrate in a housing. For a gas treatment device made using the “stuffing” process, the outlet of the stuffing cone has a smaller inside diameter than that of the housing, so the mat support will not catch on the edge of the housing when the substrate is inserted into it. The stuffing cone produces a high load on the substrate, which can be more than twice as high as after the substrate has been initially installed in the housing. Similarly when “stuffing” two substrates in one operation, and while using good manufacturing practices to align the substrates, the unavoidable misalignment that occurs can also increase the substrate load to about twice as high as when installing only one substrate in a housing. While this misalignment can be mitigated by installing the substrates separately, doing so complicates assembly and raises costs.

Since excessive mat forces can cause the substrate to fracture, it is necessary to limit the maximum mount density. An “INTERAM 100” mount density of about 1.12 g/cm³ in the housing is a typical upper limit for an assembly of two thin wall substrates “stuffed” at one time, having 600 cpsi and 0.0035 inch walls. These substrates have a minimum isostatic strength, i.e. “crush strength” when applying a uniform load to the outer radial surface of the substrate, of greater than about 220 pounds per square inch (psi). Thinner wall substrates such as, for example, those with 900 cpsi and 0.0025 inch thick walls have a minimum isostatic strength of greater than about 75 psi. Since the isostatic strength for these thin wall substrates is relatively low, the mount density for exhaust treatment devices which use them must be reduced, and also controlled carefully within certain ranges, to ensure proper substrate retention without causing fractures as well as acceptable levels of mat erosion.

FIG. 1 is a graph from the “3M” Company, Minneapolis, Minn., of initial pressure on a substrate versus mount density obtained by compressing “INTERAM 100” mat samples having a basis weight of 3100 g/m² to the mount densities shown, and then recording the resulting pressure. The substrate pressure obtained will vary with different mat materials. A mat support with a lower basis weight will produce a lower mount density for a given annular space, and therefore a lower substrate pressure. Holding other parameters constant, a larger annular space will also tend to lower the substrate pressure. FIG. 1 can also be used, based on mount density immediately after assembly, to determine the pressure on a substrate during installation in a housing (assuming no additional loads due to excessive substrate misalignment, etc.). According to FIG. 1, for current design ranges, pressures on the substrate can vary from about 20-140 psi as mount densities vary from about 0.85-1.10 g/cm³. When these pressures are doubled twice, once to account for the additional load of the stuffing process (using a conventional housing and stuffing cone), and once again to simulate the unavoidable misalignment from assembling two substrates in one step, these pressures can increase to about 80-560 psi. At some of these higher pressures, relatively thin 0.0035 inch wall, 600 cpsi substrates are just strong enough to be assembled without an excess rate of fracturing. Thinner 0.0025 inch wall, 900 cpsi substrates would likely fracture at an unacceptable rate at these pressures. In order to not exceed the minimum strength of the most fragile substrates under similar assembly conditions, the maximum mount density should be limited to about 0.93 g/cm³ for “INTERAM 100” mat. At the low end of the mount density range, an average of about 0.85 g/cm³ is typically needed for “INTERAM 100” mat in order to prevent premature mat erosion, which can lead to movement of the substrate, contact of the substrate with the housing, impact due to vibration, and eventual loss of structural integrity.

What remains needed in the art is a manufacturing process that produces a selected mount density for individual gas treatment devices having a range of substrate/housing annulus conditions.

### SUMMARY OF THE INVENTION

The present invention is a gas treatment device having a substrate, a secondary support made of an inert, heat-resistant material, wherein the secondary support is disposed concentrically about at least a portion of the substrate, a primary mat support made of a fibrous, heat-resistant material, wherein the primary mat support is disposed concentrically and substantially completely about the substrate, and a housing, wherein the substrate, secondary support and primary mat support form a subassembly, further wherein the subassembly is disposed substantially concentrically within the housing, wherein the primary mat support has a region that is adjacent the secondary support, further wherein a selected mount density is produced within at least a portion of the region.

The gas treatment device according to another embodiment of the present invention includes a substrate, a secondary mat support having a secondary mat basis weight, wherein the secondary mat support is disposed concentrically about at least a portion of the substrate, and a primary mat support having a primary mat basis weight, wherein the primary mat support is disposed concentrically and substantially completely about the substrate, further wherein the secondary mat basis weight is substantially less than the primary mat basis weight.

The present invention describes a method for producing a gas treatment device, including determining a first selected length for a primary mat support for a substrate of the gas treatment device, wherein the first selected length is sufficient for the primary mat support to be disposed substantially completely about the substrate concentrically, determining a parameter of at least one subcomponent of the gas treatment device, determining a second selected length for a secondary mat support for the substrate based on the parameter, wherein the second selected length is sufficient to produce a selected mount density within the gas treatment device, forming a subassembly by disposing the first and second selected lengths concentrically about the substrate, disposing the subassembly substantially concentrically in a housing, and producing a selected mount density within at least a portion of a region of the primary mat support that is adjacent the secondary mat support.

The present invention mitigates the problems caused by variation in the size and basis weight of individual components in a gas treatment device. This is accomplished by providing a practical method for adjusting the amount of mat support used in a particular device, in order to reduce the maximum mat density and thereby significantly reduce the substrate pressure. Two pieces of mat support material are used to do this. The primary piece of mat support contains about 75 percent or more of the total amount of mat used in a given assembly, and typically has a length sufficient to encircle the substrate once. The secondary piece of mat support contains about 25 percent of the total amount of mat used or less, and can have a length from zero mm up to a length sufficient to encircle the substrate one or more times. The secondary mat in combination with the primary mat is used to obtain a selected mount density for the device. The secondary mat length is typically determined based on a measurement of a parameter of at least one subcomponent of the device. This measurement step (or steps) also facilitates adjusting the secondary mat length or peripheral location within the device under certain conditions, in order to control the maximum substrate pressure.

The parameter having the greatest effect on mount density is the circumference of the substrate, generally followed by the mat basis weight. Typically the outer periphery of the substrate is measured. Measurement of other component parameters may not be necessary if sufficient control of the maximum mat density can be accomplished through measurement of the substrate only. If more control of mat density is required, the primary mat's basis weight can be measured. Alternatively, or in combination with the substrate outer periphery and/or mat basis weight, the inner periphery of the housing can also be measured and used. These measurements are then preferably entered automatically into a computer program to calculate the required secondary mat length. This length is then automatically cut from a roll of the material. The primary or secondary mat support is disposed about the substrate, followed by the other of the two, to form a subassembly. The subassembly is then installed in the housing using a conventional manufacturing process.

If multiple substrates are used in a gas treatment device, the parameters above can be measured for each respective location along the longitudinal axis of the device. Each substrate is individually wrapped with a primary mat support, and a secondary mat support determined specifically for the respective longitudinal location. The substrates are likely to have different circumferences and require different lengths of secondary mat in order to produce the selected mount density.

The present invention solves the problem of being unable to feasibly specify as single optimal basis weight for the mat support of each individual gas treatment device in a production run. It does this by combining the characteristics of primary and secondary mat supports to produce a selected mount density. Furthermore, the present invention can be used for any combination of substrates and housings within their normal tolerance ranges.

This and additional objects, features and advantages of the present invention will become clearer from the following specification of a preferred embodiment.

### BRIEF DESCRIPTION OF THE DRAWINGS

FIG. 1 is a graph of initial substrate pressure for a gas treatment device versus mount density, showing typical values for the prior art and the present invention.

FIG. 2 is a table listing mat support, housing and substrate parameters for an example of the minimum annulus condition of the prior art.

FIG. 3 is a table listing mat support, housing and substrate parameters for an example of the maximum annulus condition of the prior art.

FIG. 4 is a table listing mat support, housing and substrate parameters for an example of the maximum annulus condition, according to the present invention.

FIG. 5 is a table listing mat support, housing and substrate parameters for an example of the minimum annulus condition, according to the present invention.

FIG. 6 is an isometric view of a subassembly according to the present invention.

FIG. 7 is a flowchart for a method for producing a gas treatment device according to the present invention.

FIG. 8 is an end view of a subassembly according to two other embodiments of the present invention.

FIG. 9 is an end view of a subassembly according to another embodiment of the present invention.

FIG. 10 is a flowchart for a method for producing a gas treatment device according to another embodiment of the present invention.

### DESCRIPTION OF THE PREFERRED EMBODIMENT

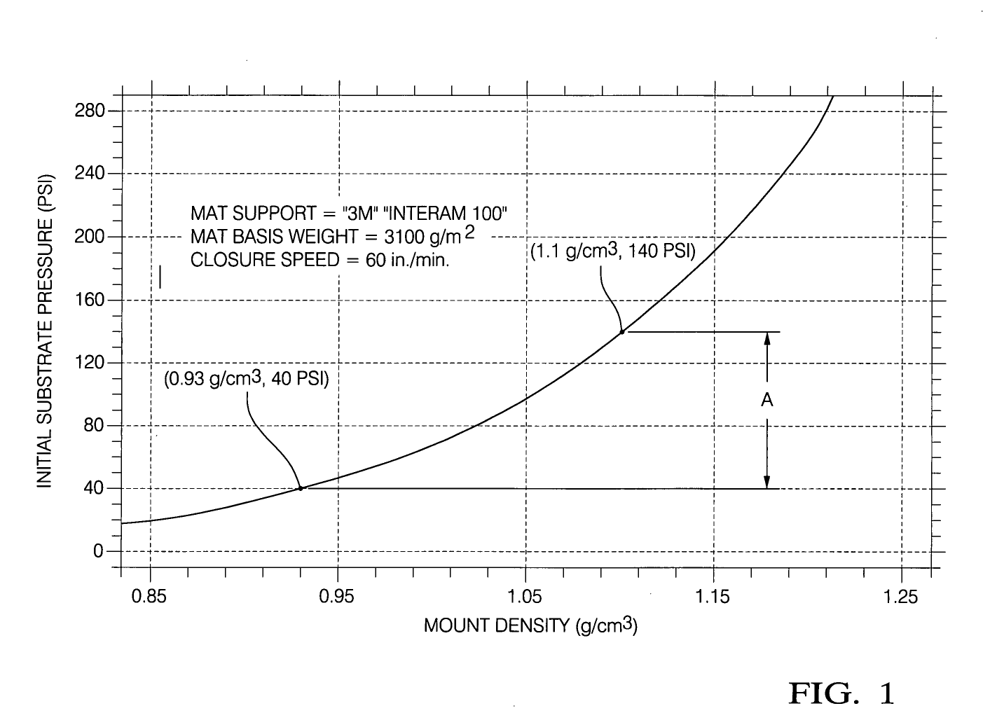

The invention can be explained generally in three steps. The first step is to determine the minimum mount density allowable for a gas treatment device application. This is done with information from a mat support company about how their products can be used. Such information helps to establish appropriate choices for the mat support material, mat basis weight and housing size, as well as the maximum and minimum mount densities, according to the prior art. The resulting maximum mount density serves to show how the present invention reduces the substrate pressure. The resulting minimum mount density is used as the minimum mount density for the intended application of the present invention. FIGS. 1-3 relate to using a mat support company's information to accomplish this.

FIG. 1 is an example of information supplied by the “3M” Company, Minneapolis, Minn., for its “INTERAM 100” mat support, showing the effect of mat density (i.e. mount density) on mat pressure (i.e. substrate pressure) for a typical gas treatment device. It shows typical values for mount density and substrate pressure which occur in current designs immediately following the installation of a single substrate within a housing. According to FIG. 1, this initial pressure can vary from about 40 psi at a moderate mount density of about 0.93 g/cm³ to about 140 psi at a typical maximum mount density of about 1.1 g/cm³.

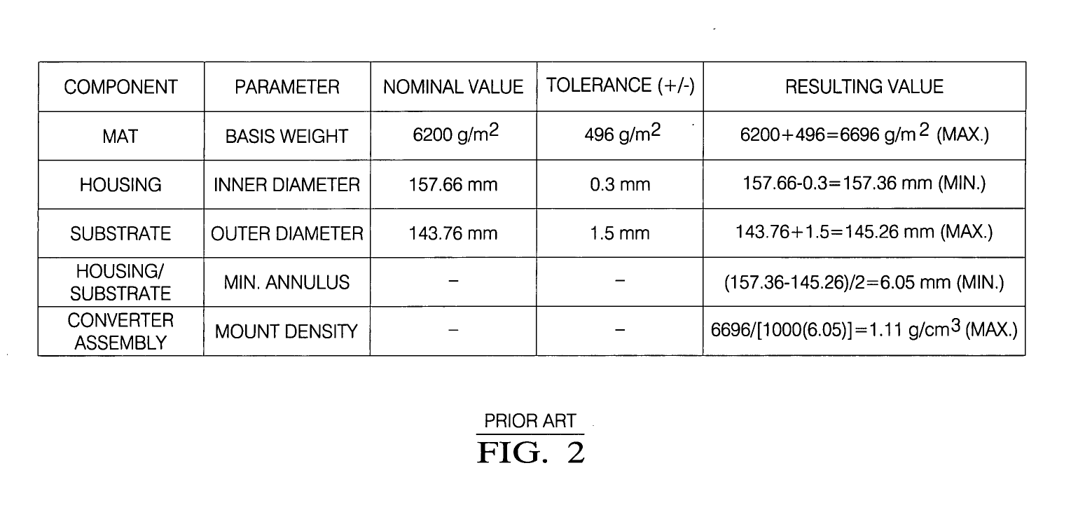

FIG. 2 shows the calculations for obtaining a maximum mount density according to the prior art of about 1.11 g/cm³ for a housing of a gas treatment device having a “minimum annulus” condition. These calculations are based on typical prior art designs, utilizing parameters with good records of performance in the field, and without the use of statistical methods for the various component tolerances (which would tend to reduce the magnitude of the tolerance “stack ups” in FIG. 2, since the cumulation of all tolerances at their worst case occurs rarely). A typical round ceramic substrate can have an outside diameter (O.D.) of 143.76 mm with a tolerance of +/−1.5 mm. Therefore the maximum O.D. for the substrate of this example is 145.26 mm. A typical gas treatment device housing fabricated from SAE 51409 stainless steel can have an inner diameter (I.D.) of 157.66 mm with a tolerance of +/−0.3 mm. Therefore the minimum I.D. of the housing is 157.36 mm. Per FIG. 2, this combination of geometries yields a “minimum annulus” condition, with a resulting minimum annulus of 6.05 mm. At this point it is important to select a mat support having a basis weight that retains the substrate while applying the proper pressure on it. If a nominal basis weight of 6200 g/m² is chosen to encircle the substrate once, then at the upper end of the tolerance range for that mat support (about +8%, or +496 g/m², for a maximum basis weight of about 6696 g/m²), the maximum mount density will be about 1.11 g/cm³. According to FIG. 1, this will produce an initial substrate pressure of about 140 psi. Based on field performance and the comments above concerning statistical methods, the “minimum annulus” condition of this example with a nominal mat basis weight of 6200 g/m² is not so high as to make a 600 cpsi, 0.0035 inch wall substrate (isostatic strength of 220 psi) prone to an excessive rate of fracturing. However, at this initial substrate pressure a 900 cpsi, 0.0025 inch wall substrate (isostatic strength of 75 psi) would likely begin to fracture at an unacceptable rate.

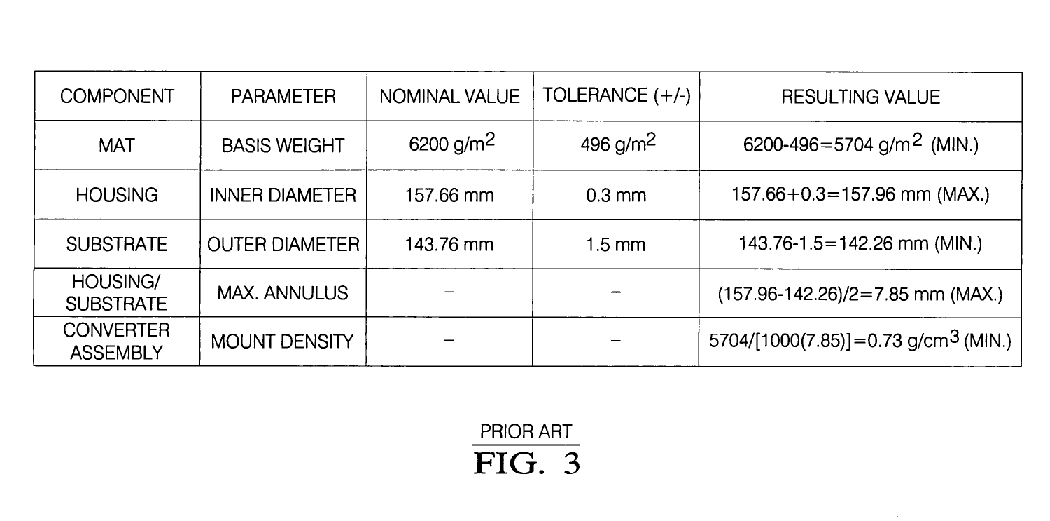

The example of FIG. 3 provides the first step in applying the invention, which is to determine the minimum mount density allowable for the intended application. FIG. 3 shows the calculations used to obtain a minimum mount density according to the prior art of about 0.73 g/cm³ for a housing of a gas treatment device having a “maximum annulus” condition. Again, these calculations are based on typical prior art designs, utilizing parameters with good records of performance in the field, and without the use of statistical methods for the various component tolerances (which would tend to reduce the magnitude of the tolerance “stack ups” in FIG. 3). The same 6200 g/m² nominal basis weight mat used for the “minimum annulus” condition of FIG. 2 must also provide sufficient mount density when the “maximum annulus” condition occurs in an individual gas treatment device. Referring to FIG. 3, the same nominal values and tolerance ranges shown in FIG. 2 but applied in their reverse directions, respectively, yield a minimum substrate O.D. of 142.26 mm and a maximum housing I.D. of 157.96 mm. Under these conditions the maximum annulus is 7.85 mm. When the substrate of this example is assembled with a 6200 g/m² mat support at its minimum basis weight (about −8%, or −496 g/m²) of 5704 g/m², the resulting mount density is 0.73 g/cm³. Based on field performance and the comments above concerning statistical methods, the “maximum annulus” condition of this example using a nominal mat basis weight of 6200 g/m² is not so low as to make the exhaust treatment device susceptible to premature mat erosion. (The application of statistical methods to the example of FIG. 3 would result in a mount density of about 0.85 g/cm³.)

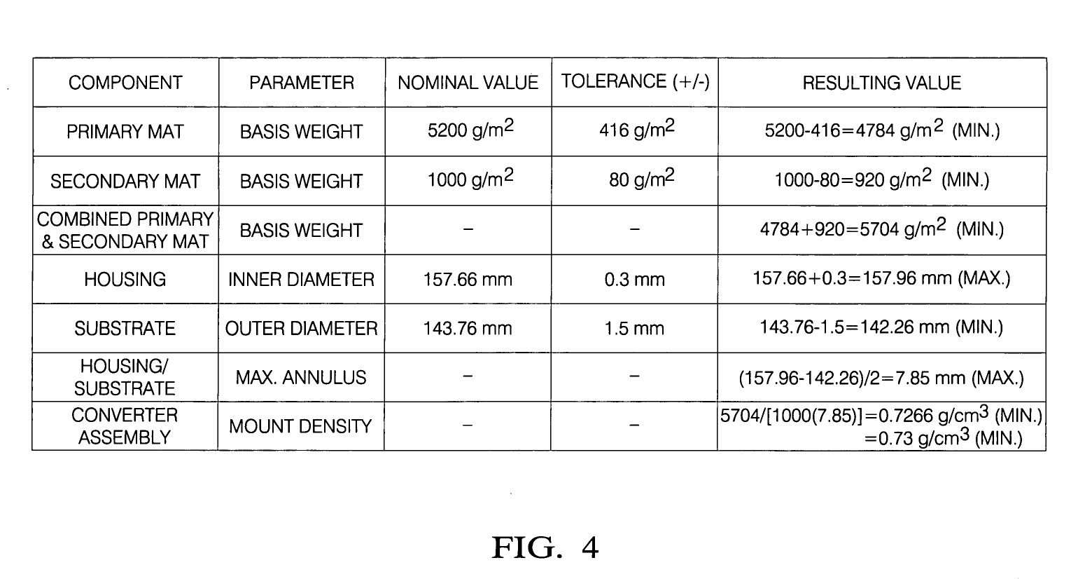

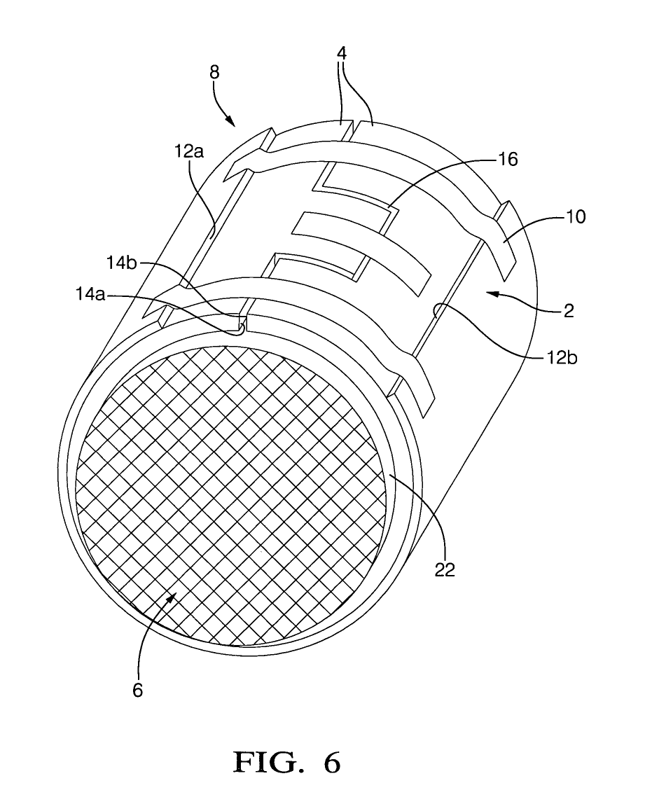

The present invention is introduced in FIG. 4, which is another example of a maximum annulus condition, with the same substrate, housing and mat support parameters as FIG. 3. According to the present invention, and also referring to FIG. 6, a secondary mat support 2 can optionally be used with a primary mat support 4, so that the total basis weight of the two mat supports together is optimized for a particular substrate 6 and housing (not shown) combination. As a result, a selected mount density is produced for each individual gas treatment device that is manufactured. The primary mat support is mainly responsible for containing the substrate within the housing. The secondary mat mainly supplies additional basis weight, if needed, to bring the mount density for the entire assembly up to a desired value. By proper selection of the primary mat basis weight (in part, so it is lower than would otherwise be the case if it were the only mat support), an ability is provided to select the secondary mat basis weight and tailor the resulting mount density, in order to account for tolerance variations in the subcomponents of the gas treatment device.

In step two of applying the invention, the basis weights of the primary and secondary mat supports are determined. This requires the use of design information from the mat supplier as well as the calculations of FIGS. 2-3. The initial basis weight of the secondary mat is typically established by choosing the lowest possible basis weight available from the supplier, for reasons discussed below, which is nominally about 1000 g/m² for “INTERAM 100” mat. Referring to FIG. 4, the primary mat basis weight for the invention is determined by subtracting the secondary mat basis weight of 1000 g/m² from the 6200 g/m² mat basis weight of the prior art designs in FIGS. 2-3. This results in a primary mat basis weight of about 5200 g/m² for this embodiment of the invention. In FIG. 4, the minimum mount density for the maximum annulus condition is also calculated. It would be known, prior to applying any mat to this substrate, that the substrate is at the low end of the size range by measuring its diameter or circumference. In the worst case condition for the secondary mat support, a secondary mat with a nominal basis weight of 1000 g/m² at the low end of its tolerance range (about −8%) has an actual basis weight of about 920 g/m². Because of the small size of this substrate, the assembly requires one wrap of 5200 g/m² primary mat and one wrap of 1000 g/m² secondary mat to achieve a minimum mount density of 0.73 g/cm³ (known to be satisfactory based on the field performance mentioned above). This matches the result obtained for the same housing and substrate combination in FIG. 3. From this it can be seen that one “wrap” each of the selected primary and secondary mat supports (i.e. mat lengths sufficient to substantially encircle the substrate once) will produce about the same substrate mounting conditions as one “wrap” of the 6200 g/m² mat support of FIGS. 2-3.

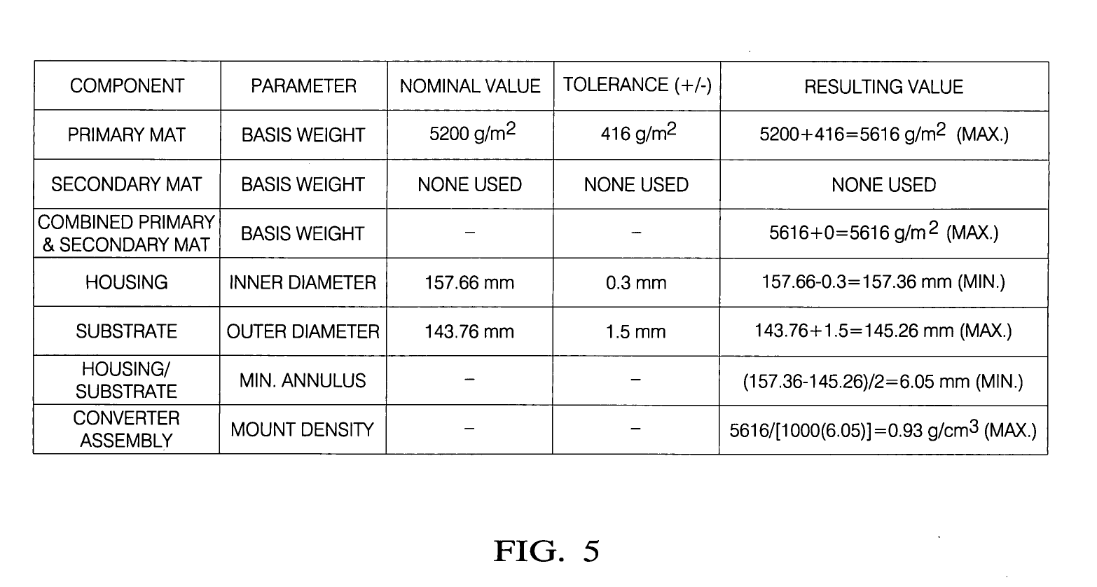

Further according to the present invention, a maximum mount density of 0.93 g/cm³ is obtained for the minimum annulus example of FIG. 5 using no secondary mat support. It would be known, prior to determining any mat for this assembly, that the substrate was at the high end of the size range by measuring its diameter or circumference. In this case only the primary mat support is used in order to properly limit the mount density. In the worst case condition, a primary mat support with a nominal basis weight of 5200 g/m² at the high end of its tolerance range (about +8%) has an actual basis weight of 5616 g/m². In FIG. 5, this yields a maximum mount density for the assembly of 0.93 g/cm³. According to FIG. 1, at this mount density an initial substrate pressure of about 40 psi is produced in the housing. This compares very favorably to the initial substrate pressure of about 140 psi for the prior art example of FIG. 2, resulting in a reduction of about 100 psi as shown at A in FIG. 1.

The effect of the “stuffing” process of manufacture is approximated by doubling the substrate pressure in the housing, and produces a maximum substrate pressure of about 80 psi for the gas treatment device of FIG. 5. Therefore the present invention permits successful use of thin wall substrates with 900 cpsi and 0.0025 inch thick walls (minimum isostatic strength greater than about 75 psi) under these conditions. This is due to the statistical probability that the tolerance stack ups are not likely to all be in their worst case condition at one time, as was also assumed for FIGS. 2-4 above. It should be noted that the present invention can also be applied using the “clam shell” process of assembly.

In step three of applying the invention the proper length for the secondary mat support is determined. The length of the secondary mat is unique to a given exhaust treatment assembly. In the example of FIG. 5 above, no secondary mat was required for the minimum annulus condition when a nominal basis weight of 5200 g/m² was used for the primary mat support. But similar exhaust assemblies with annular gaps greater than the minimum annulus condition would benefit from using a secondary mat support to achieve the proper mount density. For the maximum annulus example of FIG. 4 above, one wrap of primary and one wrap of secondary mat support was used. However, the invention also applies where more or less than one full wrap of secondary mat is needed to produce a selected mount density.

In one embodiment of the invention, it is desirable that the longest piece of secondary mat be sufficient to encircle the substrate no more than once. To obtain this, the basis weight of the secondary mat may have to be adjusted above 1000 g/m² for some designs, in order to provide the desired control over the mount density. When there is one wrap of secondary mat or less, the secondary mat can be placed on top of the primary mat during assembly on a horizontal surface. Both layers of mat can then be disposed about the substrate in one operation. The variable length secondary layer will be against the substrate, held in place by the primary layer. Then only one mat joint is produced, which can be adhesively taped to keep the primary layer temporarily in place prior to disposing the substrate in the housing. However, with reference to FIG. 6, it is also contemplated that this arrangement of support layers can be reversed, so that the primary mat support is disposed concentrically about the substrate, followed by the secondary mat support disposed concentrically about at least a portion of the primary mat support. Adhesive tape 10 or other means of temporarily holding the secondary and primary mats in place, such as glue, staples, etc., may be used. This assists the operator with handling the substrate/mat subassemblies and getting them properly loaded into the appropriate apparatus for completing the manufacturing process.

A single mat support with a single basis weight chosen specifically for the geometry of an individual exhaust treatment device might be used to achieve a selected mount density. However, mat supports typically come in certain categories of basis weight and are shipped in commercial quantities of hundreds of feet per roll of material. It is not practical to have a large number of these basis weights on-hand in an assembly area. The present invention solves the problem of being unable to feasibly specify a single optimal basis weight for the mat support of each device in a production run. In effect, a length of one wrap of a “target mat support” having a selected optimal basis weight is approximated by one wrap of a primary mat support in combination with a sufficient length of a secondary mat support. According to the present invention, the basis weight of the secondary mat support is substantially less than that of the primary mat support. The length of the primary mat support remains at substantially one wrap, as with existing devices. Whereas the primary mat could be longer, typically this would not be done due to increased cost, and the possibility of a higher rate of erosion for multiple layers of mat having a total thickness of 8 mm or more in the housing. The length of the secondary mat varies for individual devices from as little as none to up to one wrap, or even up to several wraps about the substrate. Referring to FIG. 6, secondary mat support edges 12a and 12b, which define the length of a secondary mat, are not aligned in any particular relationship to similar primary mat support edges 14a and 14b. The primary mat's tongue and groove joint 16 is relied upon for sealing the annular cavity between the substrate and housing. As such, it is not necessary for secondary mat support edges 12a and 12b to be in contact. The length of the secondary mat support can be determined from the following equation:
L₁BW_{T}=L₁BW_{P}+L₂BW_{S}
where,
L₁=length of the primary mat support
L₂=length of the secondary mat support
BW_{T}=basis weight of the target mat support
BW_{P}=basis weight of the primary mat support, and
BW_{S}=basis weight of the secondary mat support

This assumes that the widths of the primary and secondary mat supports are about the same, i.e. substantially the same as the length of the substrate's small channels for exhaust gases to flow through. Several observations can be made from the equation above. First, if the basis weight of the primary mat support is substantially the same as that of the target mat support for a particular device, then no secondary mat is needed. By contrast, the basis weight of the secondary mat support will not approach that of the target mat support. The secondary mat's basis weight is selected so as to “fine tune” the combined basis weight of the two mat supports, via its length. And the lower the basis weight of the secondary mat, the longer its length becomes for a given small correction in mount density, which tends to make it easier for a production operator to handle when assembling the device. Second, the basis weight of the secondary mat required is inversely proportional to its length. For example, if the secondary mat basis weight is tripled, its length will become one third of the original value. Third, as stated immediately above, the length of the secondary mat is adjustable via selection of its basis weight. The reasons for desiring certain combinations of basis weight and length will be further explained below. Rearranging the equation for mount density above:
Mat Basis Weight(g/cm²)=Annular Space(cm)×Mount Density(g/cm³)
Inserting this expression into the equation for the variable mat process:
L₁BW_{T}=L₁BW_{P}+L₂BW_{S} or
L₁(Annular Space)(Mount Density_{T})=L₁BW_{P}+L₂BW_{S}
where,
Mount Density_{T}=selected mount density for the target mat support

The length of the secondary mat support is preferably determined by measuring a parameter of at least one subcomponent of the gas treatment device. For example, referring to FIG. 6, the parameter can be the outer periphery 22 of the substrate and/or the inner periphery of the housing (not shown), which affect the annular space in the equation above. Other possible parameters include the primary and/or secondary mat basis weights. If, for example, only the outer periphery of the substrate is actually measured, then nominal values would need to be used for the inner periphery of the housing and the primary and secondary mat basis weights. Applying the parameters for the gas treatment device of FIG. 4 (maximum annulus condition) to the equation above:
π(0.14226 m)(0.00785 m)(0.7266 g/cm³)(100 cm/1 m)³=π(0.14226 m)(4784 g/m²)+L₂(920 g/m²)
for,
L₁=π(substrate outer dia.ₘᵢₙ)=π(0.14226 m)=0.447 m
annular space=7.85 mm
Mount Density_{T}=0.7266 g/cm³ (note: more significant digits used here than for the value 0.73 g/cm³ in the description of FIG. 4 above)
BW_{P}=4784 g/m²
BW_{S}=920 g/m²
   It would be common in a production run to use nominal values for the primary and secondary mat basis weights (5200 and 1000 g/m², respectively) instead of measured or, as in this case, calculated values. Solving the equation above for L₂, L₂=0.447 m, which is the same as L₁. FIG. 4 showed an example of determining mount density according to the present invention, given a length of one wrap for both the primary and secondary mats. A result consistent with that of FIG. 4 (i.e. L₁=L₂) has been obtained here for determining the length of the secondary mat support using the parameters from FIG. 4. For the equation above, L₂ becomes less than one wrap for any annulus smaller than the maximum value (assuming the same basis weights are used).

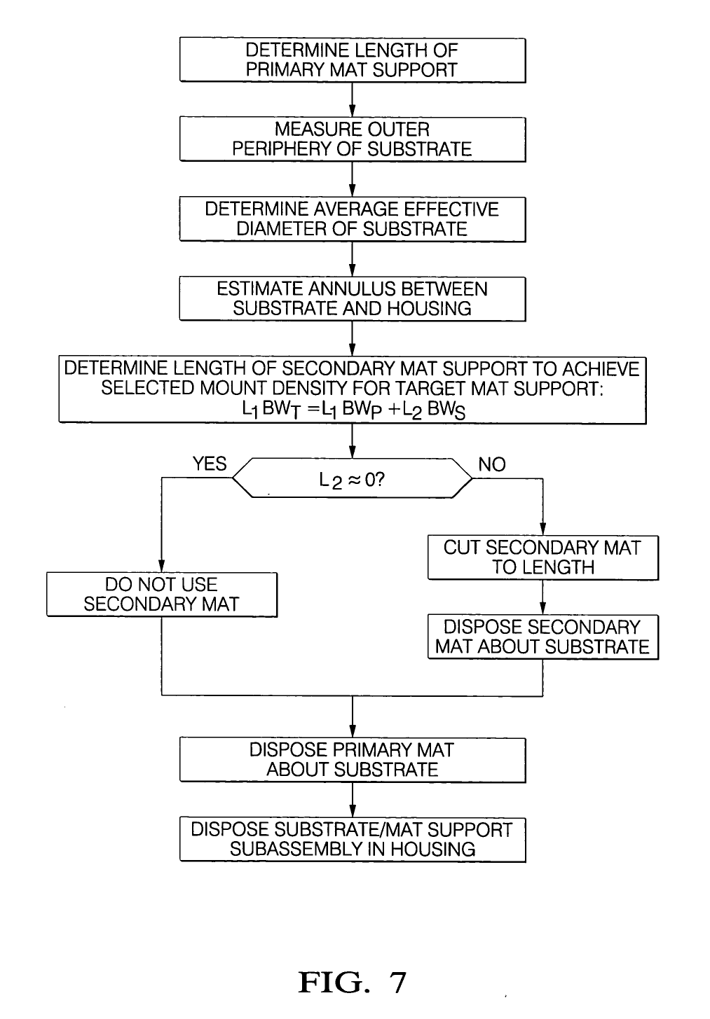

Referring to FIG. 7, a method for making a gas treatment device is described. First, the length of a primary mat support is determined by cutting the mat at the specified nominal length. In other words, although the primary mat support could be cut-to-length for each individual assembly, a certain length for all assemblies of a given kind is normally used, with a tongue and groove feature providing the necessary accommodation for substrate peripheries which vary within normal tolerances. Next, the “average effective diameter” of the substrate is determined based on at least one measurement of the substrate for an individual assembly. Since the outer periphery or circumference of the individual substrate will vary depending on the location along the longitudinal axis of the substrate where the measurement is made, the eccentricity of a round substrate, etc., any known technique can be used to obtain a reliable value for the outer periphery or circumference, including measuring at more than one location along the longitudinal axis, rotating the substrate while scanning the surface with an optical scanner measuring system, etc. The term “average effective diameter” can also be employed with nonround substrates (ex. oval, elliptical), in the sense that at least one actual measurement is taken of the outer periphery for use in estimating the annulus. Note that measuring the periphery permits the use of a more accurate figure for the primary mat support length L₁ in the equation above than the nominal value, even when no separate step of cutting a length for the primary mat support is actually used in the process. This can lead to a more accurate determination of the secondary mat length L₂ needed to achieve a selected mount density.

Once a value has been obtained for the average effective diameter, the annulus can be calculated based on either a measured value for the housing's inner periphery, or estimated from a nominal value for the housing design. The reason for generally measuring each individual substrate is that variation in the substrate periphery tends to provide the largest contribution to variation in the annulus. Then, having the annulus and the nominal basis weights of the primary and secondary mat supports, and the selected mount density of the target mat support, the variable mat process equation above can be solved for the length of secondary mat support. One or more of these steps can be automated or integrated using computers so as to reduce the chance of human error.

If the determined length of the secondary mat is zero mm or nearly zero mm, the device is assembled using no secondary mat. However, if the length is greater than a selected minimum value (that is practical for an operator to handle during assembly, for example), then the secondary mat is cut at the determined length. Either the primary or the secondary mat support can be wrapped first around the substrate, followed by the other of the two.

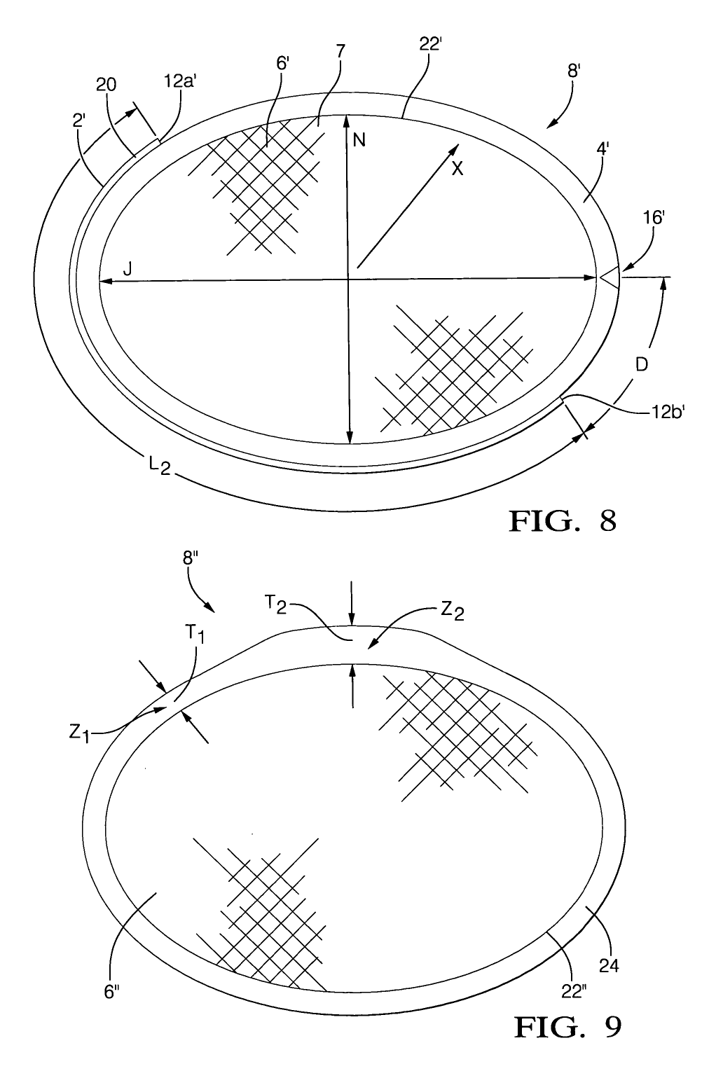

Referring to FIG. 8, another embodiment of the present invention is a gas treatment device comprising a substrate 6′ and a secondary support 20 made of an inert, heat-resistant material wherein the secondary support is disposed concentrically about at least a portion of substrate 6′. This secondary support can be considered as a spacer, and performs the function of the secondary mat support described above, which is to provide additional support material within the annular space (not shown) in order to increase the mount density to a selected value by effectively reducing the size of the annular space. Applications or instances may arise where an inert material is better suited to this function than the mat support materials described above. This may be, for instance, when an intumescent or nonintumescent secondary mat support is not readily available in a particular basis weight, or when there are cost benefits from handling only one mat support material (i.e. the primary mat support) in a production facility instead of two. The term “inert” is used herein to include materials such as metals like steel alloy sheet metals, and further to distinguish such materials from the intumescent and nonintumescent materials typically relied on to provide a desired substrate support environment with material properties including basis weight. The device of FIG. 8 further comprises a primary mat support 4′ made of a fibrous, heat-resistant material that is disposed concentrically and substantially completely about the substrate. The primary mat support also has a tongue and groove joint 16′ for sealing the annular cavity between the substrate 6′ and the housing (not shown). Either the secondary support or the primary mat support can be disposed about the substrate first, followed by the other of the two. The term “fibrous” material includes the flexible intumescent or nonintumescent mat support materials typically relied on to provide a desired substrate support environment that are described above. The term “heat-resistant” means capable of withstanding the relatively high temperatures which are common in gas treatment environments, as described above. In one embodiment, the secondary support is made from one of the stainless steel alloys recited above for making housings for gas treatment devices. The width (not shown) of the secondary support is substantially the same as the length of the substrate's small channels for exhaust gas flow. The length and thickness of the secondary support are, within a range of practical combinations for the two parameters, sufficient to take up space within the annulus to create a net desired volume or cavity (not shown) between the substrate and housing. A single primary mat support having a selected nominal basis weight will then achieve a selected mount density when the secondary support, primary mat support and substrate are assembled and disposed in the housing.

Another embodiment of the present invention is a gas treatment device comprising a substrate, a secondary mat support having a secondary mat basis weight and a primary mat support having a primary mat basis weight, wherein the secondary mat basis weight is substantially less than the primary mat support basis weight. The secondary mat basis weight is preferably less than about 25 percent of the primary mat basis weight, for reasons discussed below. The secondary and primary mat supports are wrapped around the outer periphery of the substrate, i.e. about the longitudinal axis of the substrate. The longitudinal axis passes through the center of the substrate and is parallel to the direction of the majority of the gas flow through the substrate. The secondary mat support is disposed concentrically about at least a portion of the substrate—when secondary mat is needed—because its length is frequently less than one wrap. This results in only a portion of the substrate (or housing) coming into contact with the secondary mat. The secondary mat length can also be equal to or more than one wrap. In contrast, the primary mat support is generally disposed concentrically and substantially completely about the substrate. The length of the primary mat support is generally sufficient to encircle the substrate once, i.e. one wrap. But other lengths are possible, and can be obtained using the variable mat process equation above.

In another embodiment, the primary mat support is disposed concentrically and substantially completely about the secondary mat support and the substrate. This configuration provides the benefit of capturing the secondary mat support between the primary mat support and the substrate, so that the secondary mat is less susceptible to being separated from the substrate/mat support subassembly 8 of FIG. 6 during transport within a production area for a gas treatment device. However, it is also contemplated that this arrangement of support layers can be reversed, so that the primary mat support is disposed concentrically about the substrate, followed by the secondary mat support disposed concentrically about at least a portion of the primary mat support.

The substrate, secondary mat support and primary mat support form a subassembly, as indicated above. The subassembly is typically made up of one substrate, one piece of primary mat support having a nominal length for a given gas treatment device, and optionally one piece of secondary mat support with a length that is uniquely determined according to the variable mat process equation above. However, other combinations for a subassembly are feasible such as two substrates, two secondary mat supports and one or two primary mat supports. The subassembly is finished, for example, when the average effective diameter of the substrate has been determined, the length of the secondary mat support has been determined, the secondary mat support has been disposed concentrically about at least a portion of the substrate, and the primary mat support has been disposed concentrically and substantially completely about the substrate. Taping, stapling, etc. of the ends of the mat supports is optional. After the subassembly has been completed it can be disposed substantially concentrically within a housing immediately, or the subassembly can be saved in a batch and transported and disposed within housings at a later time. An advantage of the invention is that subassemblies can be transported from one manufacturing facility to another one some distance away. This is because, as indicated above, once the variation in substrate diameter has been accounted for, a large portion of the benefit of the invention has been achieved. Since the housings tend to have less geometric variation, this less critical part of the process (i.e. final assembly) can carried out at a remote site that may have somewhat less manufacturing capability. Where it is desirable to complete the manufacturing process in a separate facility, the invention is readily adaptable to this approach.

In another embodiment the primary mat support has a first selected length, which typically is the nominal length for a given exhaust treatment device. The secondary mat support has a second selected length determined according to the equation above. The first and second selected lengths extend peripherally about the substrate, i.e. about the longitudinal axis of the substrate. The second selected length is substantially different from the first selected length, and can be substantially less than the first selected length. When it is substantially less, the secondary mat becomes easier for the operator to handle and properly align with the primary mat support and substrate. However, it is contemplated that the length of the secondary mat support can also be longer than one wrap, and this result is fully supported in the equation above.

In another embodiment of the present invention, the primary mat support has a region that is adjacent the secondary mat support. The region has a surface which is in close contact with the secondary mat support after the subassembly is disposed in the housing. The second selected length is determined according to the equation above, and is sufficient to produce a selected mount density within at least a portion of the region. According to the present invention, the target mat support and the selected mount density for the target mat support are reduced to practice via the combined primary and secondary mat supports. The actual mount density within a given exhaust treatment device will vary along the periphery of the substrate from that produced within the portion, and also with respect to location relative to the longitudinal axis of the substrate. This is due to local variations in the geometries of the housing and substrate and in the basis weights of the support materials, the amount of misalignment of the substrates when two or more are used, etc. Also, the location of the secondary mat edges with respect to the periphery of the substrate affects the actual mount density, as discussed below. Therefore the target mount density is achieved for a given gas treatment device with these considerations in mind.

The primary and secondary mat supports have other important material properties in addition to their basis weights. For instance, they are compliant, and can be compressed within ranges defined by their suppliers. Generally, mat support materials with differing basis weights have similar densities as shipped and prior to assembly in a gas treatment device. Typically mat materials with a higher basis weight are thicker than those from the same supplier with a lower basis weight. These materials act like springs in the sense that have a force-displacement relationship. In general, for a given amount of substrate pressure on mat materials with differing basis weights (i.e. differing nominal thicknesses), a similar mount density is produced. Therefore, according to the present invention, the mount density of the primary mat support at a given location on the outer periphery of the substrate is similar to the mount density of the secondary mat support at that same location. Furthermore, at least for relatively short second selected lengths, a similar mount density will exist in both the primary mat support's region and in the primary mat support which is located diametrically opposite the region.

Another embodiment of the present invention has a selected mount density of about 0.85 g/cm³ to about 0.95 g/cm³. The pressure on the substrate in the housing for this range of mount density is from about 20 psi to about 48 psi, according to FIG. 1. This is considerably less than the 140 psi which is produced at the 1.1 g/cm³ mount density that is currently used for some exhaust treatment devices. In another embodiment of the present invention the substrate further comprises a catalyst, as catalytic converters for diesel and gasoline engines are among the devices utilizing thin wall substrates that would benefit from the lower pressures placed on those substrates by the invention. Other devices that could benefit similarly from the substrate retention design and method of the invention include the group consisting of adsorbers for oxides of nitrogen, evaporative emissions devices, hydrocarbon scrubbing devices, diesel particulate traps, nonthermal plasma reactors and fuel cell reformers.

Furthermore, the present invention is applicable to a gas treatment system comprising a gas treatment device comprising a substrate, a secondary mat support having a secondary mat basis weight, wherein the secondary mat support is disposed concentrically about at least a portion of the substrate, a primary mat support having a primary mat basis weight, wherein the primary mat support is disposed concentrically and substantially completely about the substrate, further wherein the secondary mat basis weight is substantially less than the primary mat basis weight, a housing, wherein the substrate, secondary mat support and primary mat support form a subassembly, further wherein the subassembly is disposed substantially concentrically within the housing, and an exhaust system component in fluid communication with the housing. Upon disposing the substrate/mat support subassembly within the housing, each end of the gas treatment device can be individually attached and placed in fluid communication with one or more compatible exhaust system components to form a gas treatment system. The exhaust system components can comprise a coupling apparatus, flexible coupling apparatus, connecting pipe, exhaust manifold assembly, end plate, end cone, as well as combinations comprising at least one of the foregoing exhaust system components, and the like employed alone or in combination with a mat protection device such as a mat protection ring, end ring, retainer ring, as well as combinations comprising at least one of the foregoing devices, and the like.

Referring to FIG. 9, another embodiment of the present invention comprises a substrate 6″ having an outer periphery 22″, a mat support 24 disposed concentrically and substantially completely about the substrate, further wherein the substrate and the mat support form a subassembly 8″, and a housing (not shown), wherein the subassembly is disposed substantially concentrically within the housing, wherein the mat support has first and second zones Z₁ and Z₂ along the outer periphery having first and second selected thicknesses T_{1 and T}₂, respectively. The first and second zones can be identified along the outer periphery of the substrate by x-ray analysis, cutting through an exhaust treatment device in a direction transverse to its longitudinal axis, or other means of inspection. The second selected thickness is greater than the first selected thickness because the second zone is where a secondary mat support would have initially been assembled adjacent a primary mat support. After a time of usage and normal thermal cycling for the exhaust treatment device, the boundary between two separate mat supports can become blended into what may appear to be a substantially continuous mat support, in this case with two different thicknesses. (The present invention also includes more than two zones with different thicknesses.) A mat support with this appearance is contemplated by the invention, having the necessary additional mat material within the annular space to produce a selected mount density. This additional mat material also manifests itself by a higher weight per unit area for the mat support in the second zone. This weight per unit area can be called the basis weight, and is the same parameter used above to describe primary and secondary mat support materials. Therefore the first zone has a first selected basis weight, and the second zone has a second selected basis weight which is higher than the first selected basis weight.

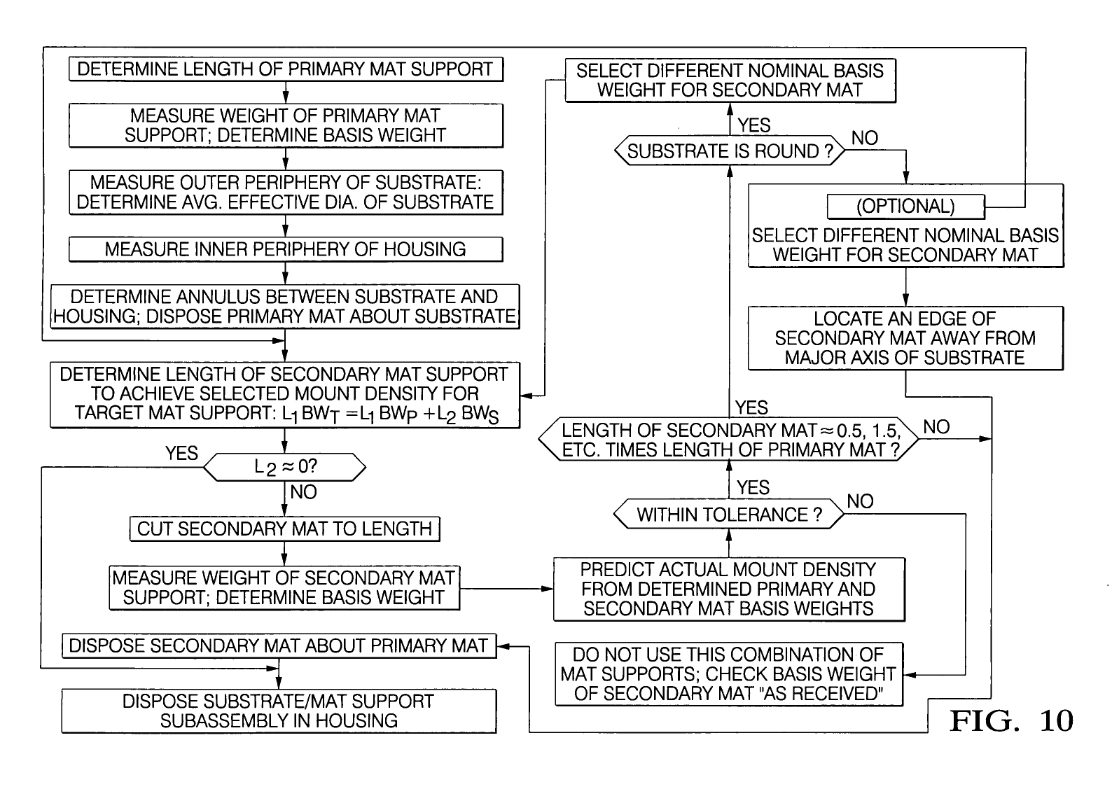

Referring to FIG. 10, another embodiment of the present invention includes determining a parameter of at least one subcomponent of the gas treatment device prior to assembly, such as the weight of the primary mat support. Given the weight of the piece of primary mat support that is to be used in a particular exhaust treatment device, and using nominal or measured values for the length and width of this particular support, the actual basis weight can be determined. Then instead of using the nominal basis weight of the primary mat support in the equation above, the actual basis weight is used, which can lead to a more accurate determination of the secondary mat support length L₂.

Referring to FIG. 10, another embodiment of the present invention includes determining a parameter of at least one subcomponent of the gas treatment device such as the inner periphery of the housing. Together with the average effective diameter determined for the substrate as described above, the actual annular space for this particular combination of housing and substrate can be calculated. Using this actual annular space in the equation above can lead to a more accurate determination of the secondary mat support length L₂. Using the actual annular space can be done together with, or independently from, measuring the weight of the primary mat support. It is also contemplated that the measured value for the inner periphery of the housing can be used together with the nominal (unmeasured) value for the outer periphery of the substrate in determining the length of the secondary mat support. However, it would be more typical to use a measured value for the outer periphery since, as discussed previously, this parameter tends to vary the most within the pertinent group of parameters affecting the construction of an exhaust treatment device, and therefore has the largest effect on the mount density of a device. It is further contemplated that actual measurements of or nominal values for the substrate outer periphery, housing inner periphery, and primary and secondary mat weights can be utilized in the equation above for secondary mat length in any possible combination, or using any of these parameters individually.

If the weight of the secondary mat support is used to determine the actual basis weight for the particular piece of secondary mat support in a fashion similar to that described above for the primary mat, then the actual mount density after disposing the substrate/mat support subassembly in the housing can be predicted according to the equation above with a higher degree of confidence. In this fashion, and prior to actually disposing the subassembly in the housing, the predicted actual mount density can be compared to the selected mount density to see if the predicted value is within a desired tolerance range. If the predicted mount density is not within the tolerance range, this combination of primary and secondary mat supports would not be used to assemble this particular device. This situation may be indicative of a problem with some aspect of the production process such as, for example, that the basis weight of the support materials as-received are not within their normal tolerance ranges.

Referring again to FIG. 6, it is desirable that the secondary mat support 2 be of the lowest possible basis weight relative to the primary mat support 4, to avoid increased local mount density at the ends or edges 12a and 12b of the secondary mat (and the resulting increased substrate pressure due to the “edge effect”). The secondary mat basis weight should preferably be less than about 25 percent of the primary mat basis weight, or more preferably less than about 15 percent of the primary mat basis weight. A secondary mat with a basis weight of about 25 percent of the primary mat basis weight generally results in one wrap or less of secondary mat being required to adjust for substrate and mat tolerances. This is desirable for the reasons concerning assembly stated above. When the substrate is very fragile, a secondary mat basis weight of less than 15 percent of the primary's is desirable, but this may require two or more wraps of the secondary mat support to properly adjust the mount density for tolerances.

The “edge effect” is heightened when the secondary mat edges or transition points are spaced 180 degrees apart along the periphery of a round substrate. The edge effect produces increased local mount density because movement of the longitudinal axis of the round substrate away from the longitudinal axis of the shell cannot readily occur when the secondary mat length is an odd multiple of one-half the length of the primary mat (0.5 L₁, 1.5 L₁, etc.). This movement is a normal occurrence in making an exhaust treatment device by the method of the invention, and is in response to the additional force initially placed on the substrate when secondary mat support has been added to one side of the substrate. However, the configuration of one-half wrap of secondary mat, or other odd multiple, tends to constrain the substrate in such a way as to tend to prevent this normal movement (to a position that is substantially concentric within the housing) from occurring. When L₂ is less than 0.5 L₁, for example, a round substrate can “move away” from the secondary mat in order to equalize the mount density within the device, and when L₂ is between 0.5 L₁ and 1.5 L₁ for example, the substrate diameter is less than its nominal value and the substrate can withstand the effect of the mat edges better.

One way to mitigate the edge effect is to use two different secondary mat basis weights, such that the length of the secondary mat support can be recalculated using a different basis weight. During the mount density calculation with the “lighter” (i.e. lower basis weight) of the available secondary mat materials, if the mat length will approach one-half wrap, etc., a “heavier” (i.e. higher basis weight) secondary mat is automatically chosen for the assembly. Per the equation above, this heavier secondary mat would be shorter, thus preventing the edges from occurring 180 degrees opposite each other when wrapped about the substrate.

Referring again to FIG. 8, another way to minimize the edge effect for a nonround substrate 7 when L₂ is one-half wrap, etc., is to locate one of the edges of the secondary mat 12a′, 12b′ a distance D along outer periphery 22′ away from the major axis J or minor axis N of the nonround substrate 7. Then, for example, when locating such an edge 12b′ a distance D away from major axis J, the secondary mat first covers a large periphery of minor axis N of nonround substrate 7. This configuration does not increase the mount density as rapidly as when the edge is located near a major axis, because one minor axis and one major axis of the substrate have no secondary mat 2′. This allows the center of the substrate to move slightly in direction X toward the major and minor axis of the substrate with no secondary mat, moving the side of the substrate near the secondary mat away from that side of the housing (not shown), in order to equalize the mount density within the device. By this method of locating a secondary mat edge, the substrate has a greater tendency to move within the housing so that it is disposed substantially concentrically within the housing, thereby tending to equalize the pressure on the substrate and produce a more uniform mount density. Distance D is an amount which is sufficient to achieve this result. For a nonround substrate, the locating the edge can be combined with changing the basis weight of the secondary mat. If the length of the secondary mat is not an odd multiple of one-half the length of the primary mat 4′, or if it is and the location of an edge can be located away from the major or minor axis of the substrate, then the primary or secondary mat support is disposed concentrically about the substrate, followed by the other of the two, to form a substrate/mat support subassembly 8′. The subassembly is then installed in the housing using a conventional manufacturing process such as one of those described above.

Another way to mitigate the edge effect is to wrap the secondary mat outside the primary mat rather than inside it. Wrapping on the outer surface of the primary mat allows the relatively thick primary mat to partially distribute the pressure from the edges of the secondary mat over a larger substrate surface area, thereby minimizing the local stress on the substrate.

Another way to mitigate the edge effect is to cut the ends of the secondary mat with a sawtooth, sine wave-like shape, etc. that would vary the end point of the secondary mat. Alternatively, the thickness of the secondary mat can be “feathered” by making it progressively thinner toward the edges of the mat. These designs will distribute the higher mat load sometimes present over a larger area of the substrate, to minimize local stresses.

To minimize misalignment caused by the secondary mat when stuffing two substrates into one housing, the secondary mats are preferably located at the same position along the outer peripheries of their respective substrates. When this is done, each of the adjacent substrates tends to be displaced in the same direction relative to the longitudinal axis of the exhaust treatment device. This minimizes the opposing mat forces that otherwise may tend to occur.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A gas treatment device, comprising:
a substrate;
a secondary support made of an inert, heat-resistant material, wherein the secondary support is disposed concentrically about at least a portion of the substrate;
a primary mat support made of a fibrous, heat-resistant material, wherein the primary mat support is disposed concentrically and substantially completely about the substrate; and
a housing, wherein the substrate, secondary support and primary mat support form a subassembly, further wherein the subassembly is disposed substantially concentrically within the housing;
wherein the primary mat support has a region that is adjacent the secondary support, further wherein a selected mount density is produced within at least a portion of the region.

2. A gas treatment device, comprising:
a substrate;
a secondary mat support having a secondary mat basis weight, wherein the secondary mat support is disposed concentrically about at least a portion of the substrate; and
a primary mat support having a primary mat basis weight, wherein the primary mat support is disposed concentrically and substantially completely about the substrate;
further wherein the secondary mat basis weight is substantially less than the primary mat basis weight.

3. The gas treatment device of claim 2, wherein the primary mat support is disposed concentrically and substantially completely about the secondary mat support and the substrate.

4. The gas treatment device of claim 2, wherein the secondary mat support is disposed concentrically about at least a portion of the primary mat support.

5. The gas treatment device of claim 2, wherein the secondary mat basis weight is less than about 25 percent of the primary mat basis weight.

6. The gas treatment device of claim 2, further comprising a housing, wherein the substrate, secondary mat support and primary mat support form a subassembly, further wherein the subassembly is disposed substantially concentrically within the housing.

7. The gas treatment device of claim 2, wherein the primary mat support has a first selected length and the secondary mat support has a second selected length, wherein the first and second selected lengths extend peripherally about the substrate, further wherein the second selected length is substantially different from the first selected length.

8. The gas treatment device of claim 7, wherein the second selected length is substantially less than the first selected length.

9. The gas treatment device of claim 7, wherein the primary mat support has a region that is adjacent the secondary mat support, further wherein the second selected length is sufficient to produce a selected mount density within at least a portion of the region.

10. The gas treatment device of claim 9, wherein the selected mount density is about 0.85 grams per cubic centimeter to about 0.95 grams per cubic centimeter.

11. The gas treatment device of claim 9, wherein the substrate further comprises a catalyst.

12. The gas treatment device of claim 9, wherein the gas treatment device is selected from the group consisting of catalytic converters, adsorbers for oxides of nitrogen, evaporative emissions devices, hydrocarbon scrubbing devices, diesel particulate traps, nonthermal plasma reactors and fuel cell reformers.

13. A gas treatment system, comprising:
a gas treatment device comprising a substrate, a secondary mat support having a secondary mat basis weight, wherein the secondary mat support is disposed concentrically about at least a portion of the substrate, a primary mat support having a primary mat basis weight, wherein the primary mat support is disposed concentrically and substantially completely about the substrate, further wherein the secondary mat basis weight is substantially less than the primary mat basis weight, a housing, wherein the substrate, secondary mat support and primary mat support form a subassembly, further wherein the subassembly is disposed substantially concentrically within the housing; and
an exhaust system component in fluid communication with the housing.

14. A gas treatment device, comprising:
a substrate having an outer periphery;
a mat support disposed concentrically and substantially completely about the substrate, further wherein the substrate and the mat support form a subassembly; and
a housing, wherein the subassembly is disposed substantially concentrically within the housing;
wherein the mat support has first and second zones along the outer periphery having first and second selected thicknesses, respectively.

15. A gas treatment device, comprising:
a substrate having an outer periphery;
a mat support disposed concentrically and substantially completely about the substrate, further wherein the substrate and the mat support form a subassembly; and
a housing, wherein the subassembly is disposed substantially concentrically within the housing;
wherein the mat support has first and second zones along the outer periphery having first and second selected basis weights, respectively.

16. A method for producing a gas treatment device, comprising:
determining a first selected length for a primary mat support for a substrate of the gas treatment device, wherein the first selected length is sufficient for the primary mat support to be disposed substantially completely about the substrate concentrically;
determining a parameter of at least one subcomponent of the gas treatment device;
determining a second selected length for a secondary mat support for the substrate based on the parameter, wherein the second selected length is sufficient to produce a selected mount density within the gas treatment device;
forming a subassembly by disposing the first and second selected lengths concentrically about the substrate;
disposing the subassembly substantially concentrically in a housing; and
producing a selected mount density within at least a portion of a region of the primary mat support that is adjacent the secondary mat support.

17. A gas treatment device, comprising:
a subassembly substantially disposed within a housing, comprising:
a primary mat support, disposed concentrically and substantially completely about a substrate; and,
a secondary mat support, disposed concentrically about at least a portion of the substrate;
wherein the primary mat support is adjacent the secondary mat support; and, wherein a selected mount density is produced within at least a portion of a region comprising the primary mat support adjacent the secondary mat support.

18. The device of claim 17, wherein the primary mat support has a primary mat basis weight.

19. The device of claim 18, wherein the secondary mat support has a secondary mat basis weight.

20. The device of claim 19, wherein the secondary mat basis weight is substantially less than the primary mat basis weight.
